(19) United States
(12) Patent Application Publication
(10) Pub. No.: US 2024/0091779 A1
(43) Pub. Date: Mar. 21, 2024

(54) Histological Containment System with Cover Pad

(71) Applicant: Parhelia Biosciences Corporation, Austin, TX (US)

(72) Inventor: Nikolay SAMUSIK, Talent, OR (US)

(73) Assignee: Parhelia Biosciences Corporation, Austin, TX (US)

(21) Appl. No.: 18/468,917

(22) Filed: Sep. 18, 2023

Related U.S. Application Data
(60) Provisional application No. 63/376,184, filed on Sep. 19, 2022.

(51) Int. Cl. B01L 3/00

(52) U.S. Cl. CPC B01L 3/50853; B01L 2300/0609; B01L 2300/0816; B01L 2300/12

(57) ABSTRACT

The present disclosure provides a cover pad for a histological container having an inclined shelf for a planar support with a histological sample coupled to a topside of the planar support and a cover pad over the planar support. The cover pad is generally planar with flow guiding surfaces that intersect downward flowing fluids deposited on the planar support. A spreader surface on the cover pad disperses fluids toward the cover pad sides. The spreader surface can be angled upward, as a convex curve, to direct impinging fluids along the angled surface toward the sides. Side flow guides intersect the spreader surface angle and smoothly flow the sideways directed fluids into a vertical space between the cover pad and the planar support. Side flow bars extend longitudinally upward above the side flow guides and assist in retaining fluids onto the planar support before the fluids engage the side flow guides.

### CROSS REFERENCE TO RELATED APPLICATIONS

This application claims the benefit of U.S. Provisional Application Ser. No. 63/376,184, entitled “Histological Containment System with Cover Tile”, filed Sep. 19, 2022, which is incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The disclosure generally relates to histological apparatuses and methods. More specifically, the disclosure relates to histological apparatuses, components, and methods of use for processing histological samples, including staining tissues with reagents.

### Description of the Related Art

Histology refers to the microscopic structure of the tissues of living organisms. To study such structure, histological samples, such as tissues, are often excised from an organism, and examined with microscopes. To assist in the examination, reagents can be used to selectively react chemically with different structures in the histological sample to form a contrast between features, such as cells compared to surrounding cells. Multiple selected reagents for multiple cells can form a type of mosaic under the microscope to enable more accurate identification through the contrasts that are created. Traditionally, histological treatment has been manually performed. The placement of the reagent, spreading across the surface of the sample, time for the reagent to react and timing of rinsing, and other variables in the preparation of the sample affect the quality and success of a suitable sample for examination. Thus, automatic systems and in some cases including robotic systems have been seen as a solution to control repetitive procedures for the sample preparation. Such systems can also be used for managing multiple samples in small spaces. Such automation has led to standards on sizes of platforms and other features to promote interchangeability between manufacturers. However, within those standards, variations in design and methods occur. As one example, the containers holding the histological samples are typically an open top container to allow the robotic access to the sample. The samples can be supported on structures to allow reagents and other fluids to be placed on the sample. The fluids may not flow across the samples uniformly to allow consistent exposure to the fluids, resulting in a compromised sample preparation.

Thus, there remains a need for improvements in histological systems and components for the preparation of histological samples, particularly those systems designed for automatic processing with robotic handling systems.

### BRIEF SUMMARY OF THE INVENTION

The present disclosure provides a cover pad for a histological container having an inclined shelf to support a planar support with a histological sample coupled to a topside of the planar support and a cover pad over the planar support on an incline. The cover pad is generally planar with upwardly formed flow guiding surfaces that intersect downward flowing fluids deposited on the planar support and/shelf upward from the cover pad. A spreader surface can be formed on a top portion of the cover pad to assist in dispersing the downward flowing fluids toward sides of the cover pad. The spreader surface can be angled upward, such as with a convex curve, so that incoming fluids can be directed sideways and flow at least partially along the angled surface toward each side in addition to any centrally flowing fluid. Side flow guides at the sides of the cover pad can intersect the spreader surface angle on each side. The side flow guides can allow the fluid that is directed sideways along the angle of the spreader surface to smoothly flow into a clearance space between an underside of the cover pad and a topside of the planar support (or exposed surfaces of the shelf not covered by the planar support). A side flow bar can extend longitudinally upward on each side of the cover pad above the side flow guides. The side flow bars assist in retaining the fluid onto the shelf at an upper end of the planar support before the fluid passes under the side flow guides between the cover pad and the shelf. In operation, a planar support with a sample can be placed on the shelf, and the cover pad placed over the planar support with the clearance space. The planar support can extend longitudinally upward toward a top of the shelf further than the spreader surface on the planar support. Fluid can be dispensed onto the planar support to flow down the incline, and is at least partially directed to the sides by the angles of the spreader surface while the side flow bars assists in retaining the fluid on the planar support until the side flows encounter the side flow guides and turn to flow downward across the planar support and specimen in the space below the cover pad and above the planar support, advantageously in a capillary fashion, to prepare the sample on the planar support.

The disclosure provides a histological containment system comprising a cover pad to be placed on a planar support with a histological sample on a topside of the planar support, the planar support being placed on a container shelf, the cover pad comprising: a flow surface formed on an underside of the cover pad when the cover pad is installed over the planar support and facing the topside of the planar support; a spreader surface on a top portion of the cover pad and configured to direct fluids toward sides of the cover pad; and a side flow bar disposed toward at least one side of the cover pad, the side flow bar configured to restrain fluids along the spreader surface from flowing off the planar support past the side flow bar.

The disclosure also provides a histological containment system comprising a cover pad to be placed on a planar support with a histological sample on a topside of the planar support, the planar support being placed on a container shelf, the cover pad comprising: a flow surface on an underside of the cover pad facing the topside of the planar support; and a spreader surface on a top of the cover pad and configured to direct fluids toward sides of the cover pad to distribute flow across the surface of the planar support under the cover pad.

The disclosure further provides a histological containment system comprising a cover pad to be placed on a planar support with a histological sample on a topside of the planar support, the planar support being placed on a shelf in a container, the cover pad comprising a shape of a parallelepiped with dimensions x,y,z, where x represents the longest edge, y represents the medium-length edge, and z represents the shortest edge, further comprising two parallel spacing strips formed on an underside of the cover pad along the x edges, and wherein a y edge is chamfered at least partially across the y edge to form a spreader surface to direct flow of a fluid under the cover pad.

The disclosure provides a method of processing a histological sample, comprising: placing a cover pad over a planar support having a sample mounted on the planar support; depositing one or more fluids on the planar support that flow over the planar support and under the cover pad across the sample to create a histological staining pattern on the sample; and flowing a mounting medium over the planar support and under the cover pad.

### BRIEF DESCRIPTION OF THE SEVERAL VIEWS OF THE DRAWINGS

FIG. 1 is a schematic perspective view of an example of a histological containment system having a container with shelves for supporting cover pads over planar supports at an inclined angle and used for preparing histological samples.

FIG. 2 is a schematic top view of an example of a cover pad shown at an approximate angle suitable for insertion into the container and above the shelf of FIG. 1.

FIG. 3 is a schematic front view of the cover pad of FIG. 2.

FIG. 4 is a schematic side view of the cover pad of FIG. 3.

FIG. 5 is a schematic back view of the cover pad of FIG. 3.

FIG. 6 is a schematic bottom view of the cover pad of FIG. 3.

FIG. 7 is a schematic top view of the cover pad of FIG. 3.

FIG. 8 is a schematic top left hand perspective view of the cover pad of FIG. 3.

FIG. 9 is a detail schematic of an indicated portion on the cover pad of FIG. 8.

FIG. 10 is a schematic top view of the cover pad supported above a planar support with a histological sample on a topside with the planar support supported on the shelf.

FIG. 11 is a schematic top right hand perspective view of the cover pad supported on the planar support supported by the shelf.

FIG. 12A is a schematic back perspective view of another example of a cover pad shown at an approximate angle suitable for insertion into the container and above the shelf of FIG. 1.

FIG. 12B is a schematic back view of the cover pad at the angle shown in FIG. 12A.

FIG. 13A is a schematic back perspective view of another example of a cover pad shown at an approximate angle suitable for insertion into the container and above the shelf of FIG. 1.

FIG. 13B is a schematic back view of the cover pad at the angle shown in FIG. 13A.

FIG. 13C is schematic top view of the cover pad of FIG. 13A.

FIG. 14A is a schematic back perspective view of another example of a cover pad shown at an approximate angle suitable for insertion into the container and above the shelf of FIG. 1.

FIG. 14B is a schematic side view of the cover pad at the angle shown in FIG. 14A.

FIG. 14C is a schematic back view of the cover pad at the angle shown in FIG. 14A.

FIG. 15A is a schematic front perspective view of another example of a cover pad shown at an approximate angle suitable for insertion into the container and above the shelf of FIG. 1.

FIG. 15B is a schematic side view of the cover pad at the angle shown in FIG. 15A.

FIG. 15C is a schematic front view of the cover pad at the angle shown in FIG. 15A.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation or location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of the embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unity fashion. The coupling may occur in any direction, including rotationally. The device or system may be used in a number of directions and orientations. The order of steps can occur in a variety of sequences unless otherwise specifically limited. The various steps described herein can be combined with other steps, interlineated with the stated steps, and/or split into multiple steps. Some elements are nominated by a device name for simplicity and would be understood to include a system or a section, such as a controller would encompass a processor and a system of related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art given the teachings contained herein.

The present disclosure provides a cover pad for a histological container having an inclined shelf to support a planar support with a histological sample coupled to a topside of the planar support and a cover pad over the planar support on an incline. In at least one embodiment, the planar support can comprise a sample slide. The cover pad is generally planar with flow guiding surfaces that intersect downward flowing fluids deposited on the planar support and/or shelf. A spreader surface on a top portion of the cover pad helps disperse fluids toward sides of the cover pad. The spreader surface can be angled upward, as a convex curve, to direct a portion of impinging fluids along the angled surface toward the sides. Side flow guides at the sides intersect the spreader surface angle and smoothly flow the sideways directed fluids into a vertical space between the cover pad and the planar support. Side flow bars extend longitudinally upward above the side flow guides and assist in retaining fluids onto the planar support before the fluids engage the side flow guides.

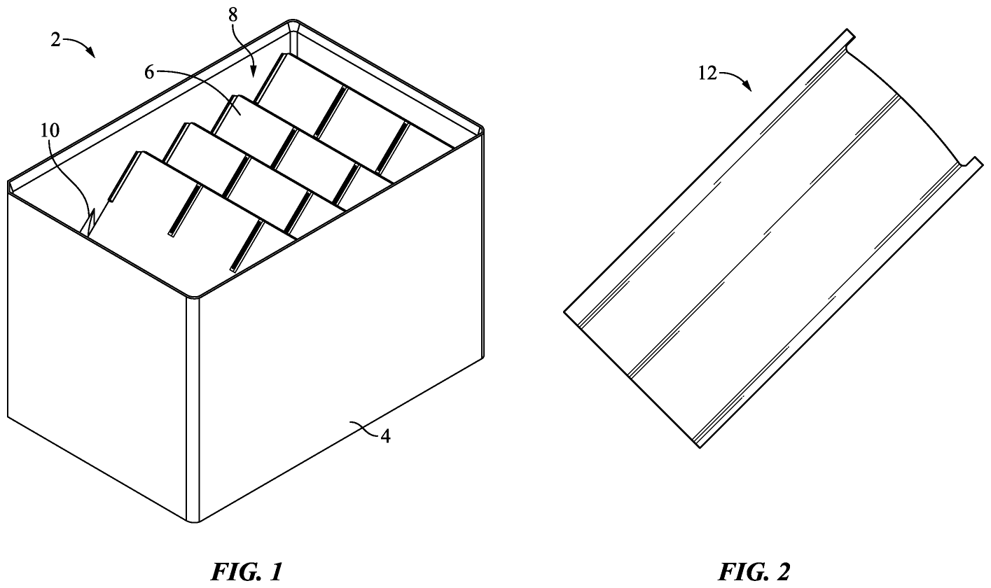

FIG. 1 is a schematic perspective view of an example of a histological containment system having a container with shelves for supporting cover pads over planar supports at an inclined angle and used for preparing histological samples. FIG. 2 is a schematic top view of an example of a cover pad shown at an approximate angle for insertion into the container and above the shelf of FIG. 1. The system 2 includes a container 4 generally having at least a partially open top 8 for ready access to components and histological samples in the container at various stages of processing the samples. The container includes one or more container supports 10, generally on the walls of the container, to support shelves 6 generally in an inclined position between 5 degrees to 85 degrees, inclusive, and anywhere in between, including 45 degrees. As described in further detail below, planar supports can be supported on the shelves 6 with cover pads 12 over the planar supports.

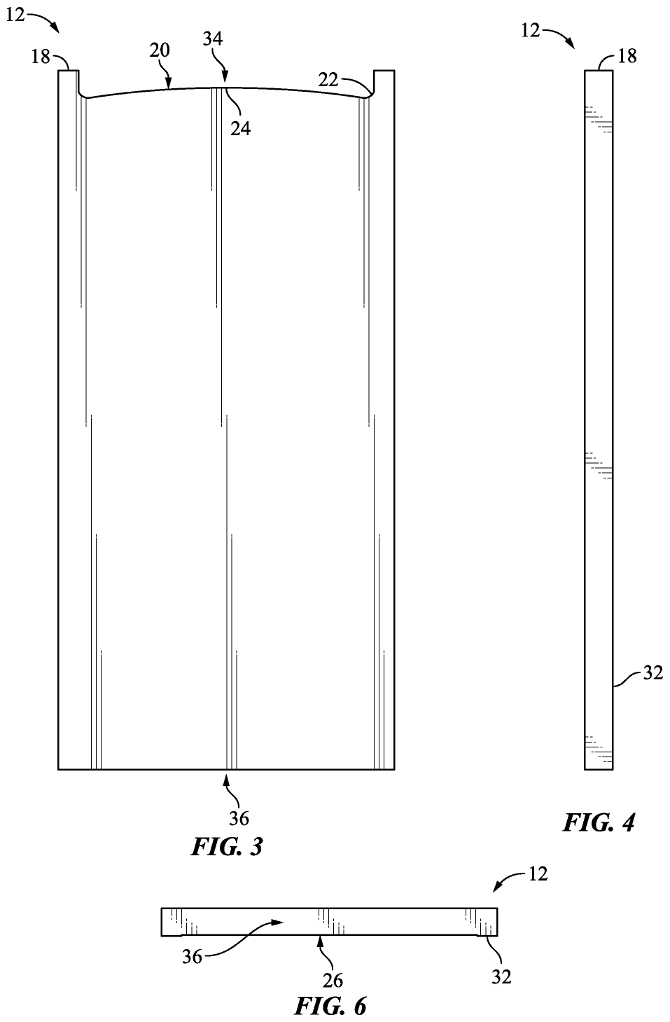

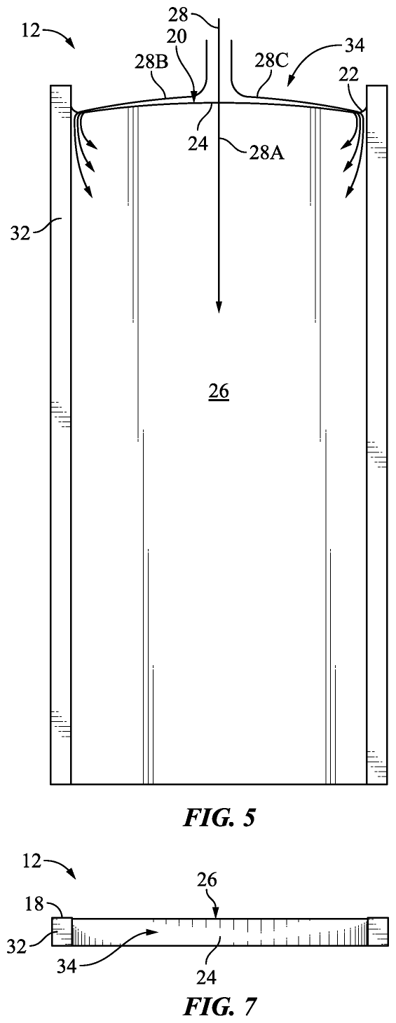

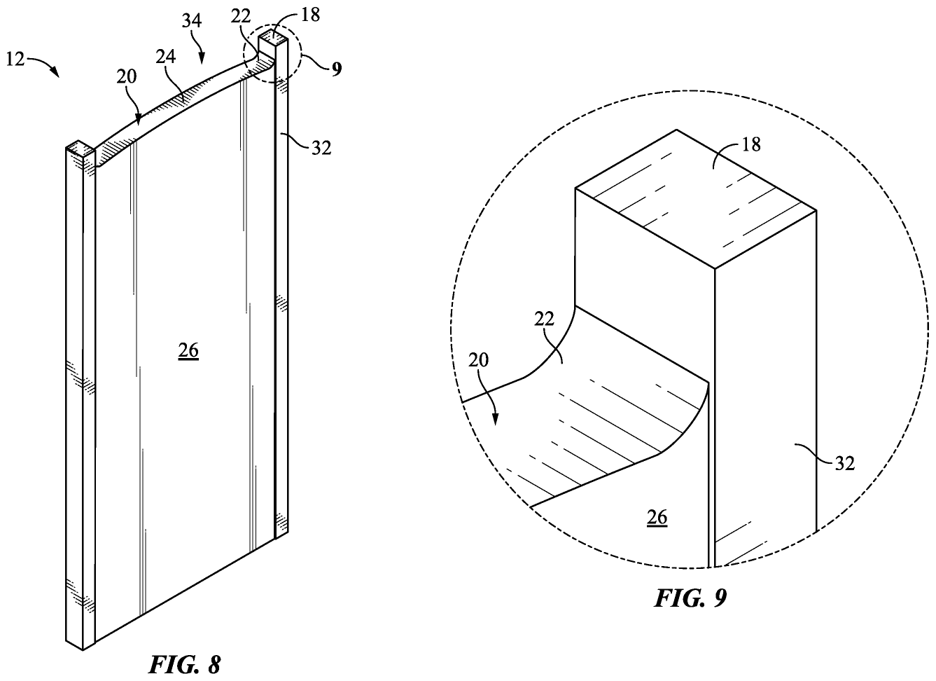

FIG. 3 is a schematic front view of the cover pad of FIG. 2. FIG. 4 is a schematic side view of the cover pad of FIG. 3. FIG. 5 is a schematic back view of the cover pad of FIG. 3. FIG. 6 is a schematic bottom view of the cover pad of FIG. 3. FIG. 7 is a schematic top view of the cover pad of FIG. 3. FIG. 8 is a schematic top left hand perspective view of the cover pad of FIG. 3. FIG. 9 is a detail schematic of the indicated portion on the cover pad of FIG. 8. The cover pad 12 is generally planar with a top 34, a bottom 36, and sides, where such terms are applied broadly and can include more than the edges of the cover pad but rather can include as applicable a top portion, bottom portion, and side portion(s).

A plurality of flow guiding surfaces increase the performance of the system 2 by increasing efficiency and uniformity of processing. One flow guiding surface is a spreader surface 20 formed on the top 34 of the cover pad 12 to assist in dispersing downward flowing fluids toward the sides of the cover pad. The spreader surface 20 can be angled upward from a laterally center portion 24 of the cover pad, such as with a convex curve, so that incoming fluids deposited on a flow path 28 longitudinally before the cover pad, such as on a planar support and/or the shelf, can be directed sideways to flow paths 28B and 28C with some fluids remaining in the center portion as flow path 28A. The sideways flow paths 28B and 28C can direct some of the fluids at least partially along the angled surface of the spreader surface 20 toward each side in addition to any centrally flowing fluids in the flow path 28A.

Another flow guiding surface is the side flow guides 22 adjacent the sides of the cover pad. The side flow guides 22 can intersect the spreader surface 20 on each side. The side flow guides 22 can allow fluids that are directed sideways along the angle of the spreader surface to smoothly flow into a vertical clearance space between the cover pad and the planar support (or exposed surfaces of the shelf not covered by the planar support).

A further flow guiding surface is a side flow bar 18 that can extend longitudinally upward on each side of the cover pad 12 above the side flow guides 22. The side flow bars 18 assist in retaining fluids onto the planar support at an upper end of the planar support before fluids pass under the side flow guides 22 between the cover pad 12 and the planar support 14.

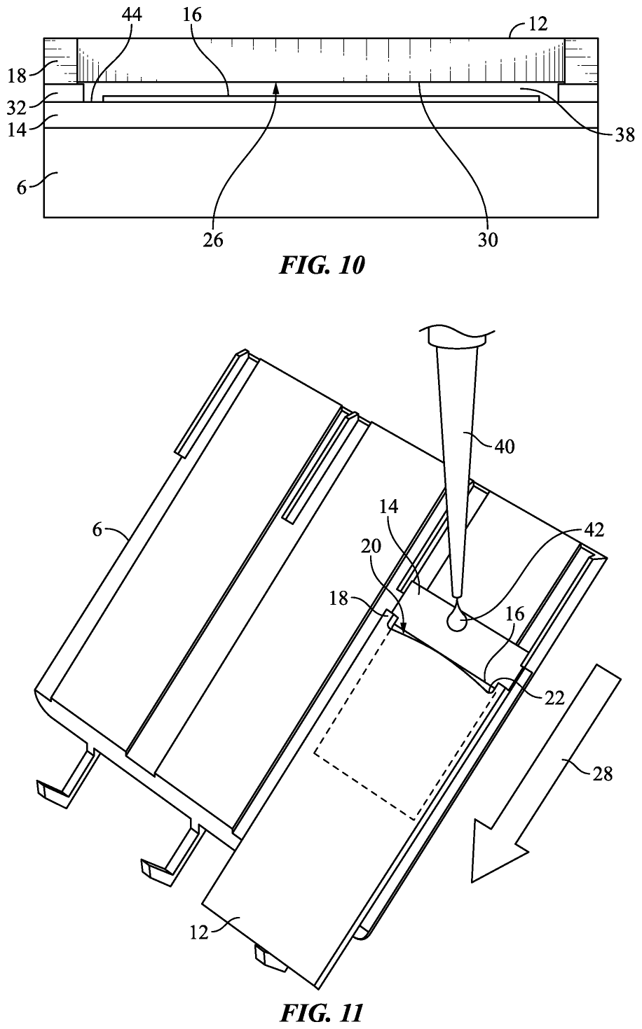

FIG. 10 is a schematic top view of the cover pad supported above a planar support with a histological sample on a topside with the planar support supported on the shelf. FIG. 11 is a schematic top right hand perspective view of the cover pad supported over the planar support supported by the shelf. In at least one embodiment, the shelf 6 supports a planar support 14 and the planar support supports the cover pad 12 with a sample 16 on the planar support under the cover pad. To assist in obtaining clearance, a spacing strip can be placed between the cover pad 12 and the planar support 14 toward each side of the cover pad. The spacing strips 32 can be planar and create (or increase) a vertical space 38 between an underside 30 of the cover pad 12 and a topside 44 of the planar support 14. The space 38 can be sized for clearance to help create a capillary effect on fluids between the cover pad 12 and the planar support 14 to promote a more uniform spread of fluids across the planar support for better preparation of a sample on the planar support. The height of the space 38 for optimum performance can be experimentally determined, as would be within the capabilities of a person of ordinary skill in the art. The spacing strips 32 can extend the full length of, for example, the cover pad 12 to retain fluids on the planar support 14 between the sides of the cover pad. The spacing strips 32 can be coupled to the cover pad 12 or to the planar support 14, integrally or as separate components. In at least one embodiment, the spacing strips 32 can be a silicone or like substance to form a seal between the cover pad and the planar support, although other materials including metals and composites can be used.

In operation, a planar support 14 with a sample 16 can be placed on the shelf 6, and the cover pad 12 placed over the planar support and supported over the planar support with a clearance space 38 between the underside 30 of the cover pad 12 and the sample on the topside 44 of the planar support. The planar support 14 can extend longitudinally upward toward a top of the shelf 6 farther than the spreader surface 20 of the cover pad 12. Fluids 42 can be dispensed by a dispenser 40, such as with a pipette or other device, onto the planar support 14 to flow down the inclined surfaces, and spread across the planar support 14 with the assistance of the flow guiding shapes. The fluids can be partially directed toward the sides of the cover pad 12 by the angled spreader surface 20 while the side flow bars 18 assist in retaining the fluid on the planar support 14 and/or shelf 6 until the sideways directed fluids encounter the side flow guides 22 and the fluids turn to flow across the planar support 14 and sample 16 in the space 38 below the cover pad and over the planar support, advantageously in a capillary fashion, to prepare the sample on the planar support.

As a further operation, a sample can be imaged in situ through a clear cover pad and even permanently mounted. For example, with the cover pad placed over the planar support with the sample mounted on the planar support, one or more fluids can be dispensed on the planar support that flow over the planar support and under the cover pad across the sample to create a histological staining pattern on the sample. Further, a mounting medium can be dispensed to flow over the planar support and under the cover pad. The process for depositing at least the one or more fluids can be iteratively repeated. Further, the mounting medium can be cured, so that the sample is permanent mounted in-situ as well. Various curing processes known to those with skill in the art can be applied, such as ultraviolet light applied to the mounting medium.

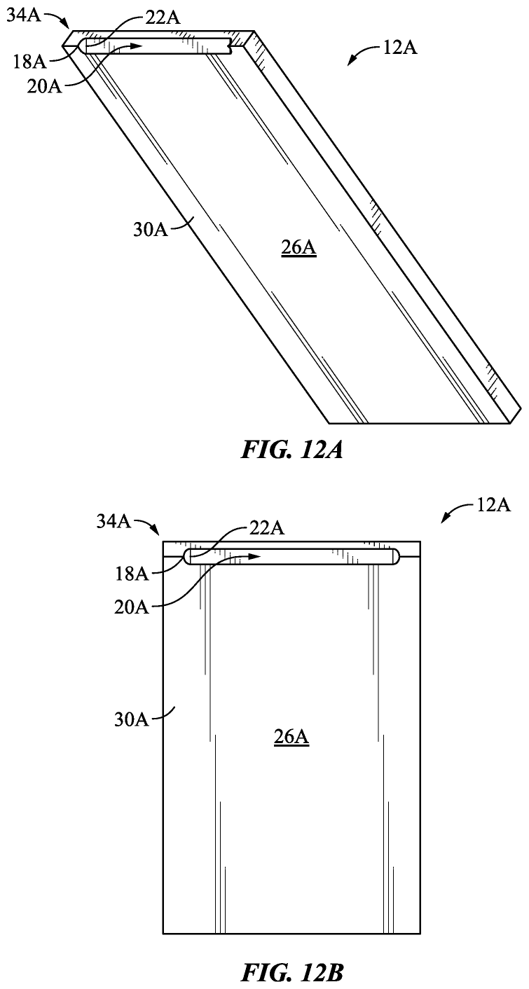

FIG. 12A is a schematic back perspective view of another example of a cover pad shown at an approximate angle suitable for insertion into the container and above the shelf of FIG. 1. FIG. 12B is a schematic back view of the cover pad at the angle shown in FIG. 12A. This embodiment of a cover pad functions similarly to the above described embodiment of the cover pad 12, in that this embodiment uses a spreader surface 20A to spread fluids across a flow surface 26A of the cover pad underside 30A. The spreader surface 20A can be formed with a side flow bar 18A in conjunction with side flow guides 22A to direct fluid flow inward from sides of the cover pad 12A.

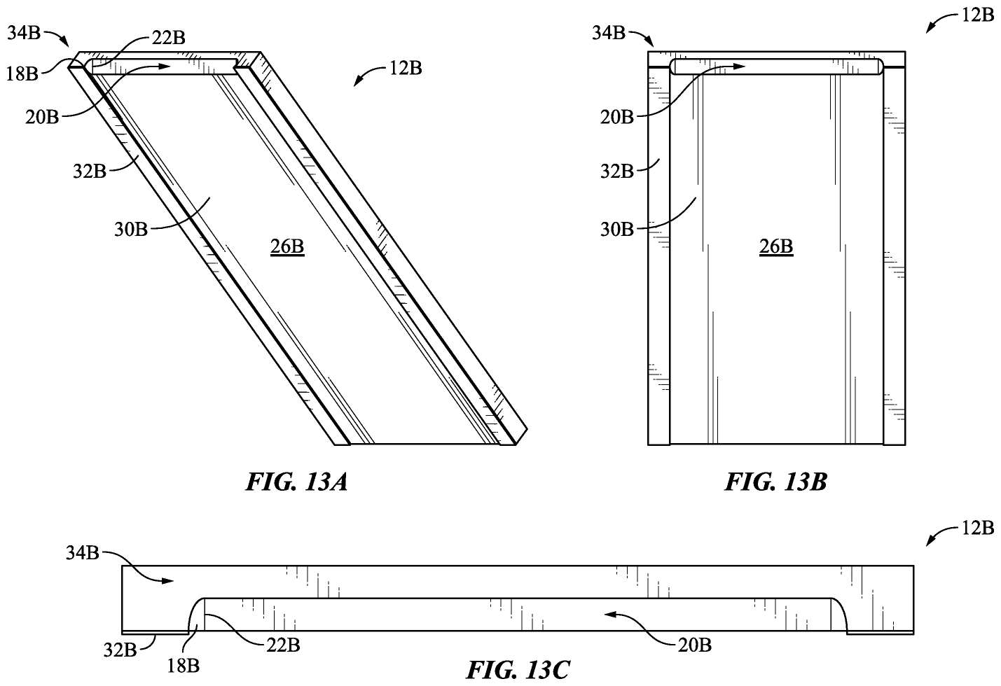

FIG. 13A is a schematic back perspective view of another example of a cover pad shown at an approximate angle suitable for insertion into the container and above the shelf of FIG. 1. FIG. 13B is a schematic back view of the cover pad at the angle shown in FIG. 13A. FIG. 13C is schematic top view of the cover pad of FIG. 13A. This embodiment of a cover pad 12B functions similarly to the above described embodiment of the cover pad 12A, in that this embodiment uses a spreader surface 20B to spread fluids across a flow surface 26B of the cover pad underside 30B. The spreader surface 20B can be formed with a side flow bar 18B in conjunction with side flow guides 22B to direct fluid flow inward from sides of the cover pad 12B. This embodiment further includes spacing strips 32B for providing a similar space 38 when the cover pad 12B is placed over the planar support surface of the shelf 6 as described above and shown in FIGS. 10 and 11.

The cover pad 12 can be described in at least one embodiment as having a shape of a parallelepiped with dimensions x,y,z, where x represents the longest edge (generally “length”), y represents the medium-length edge (generally “width”), and z represents the shortest edge (generally “thickness”). Two parallel spacing strips 32B can be formed on an underside 30B of the cover pad 12B along the x edges, and wherein a y edge connecting the spacing strips is chamfered at least partially across the length of the y edge to form a spreader surface 20B that can direct flow of a fluid under the cover pad. In the particular embodiment of FIG. 13A, the spreader surface 20B is partially along the y edge, leaving portions of the surface not chamfered.

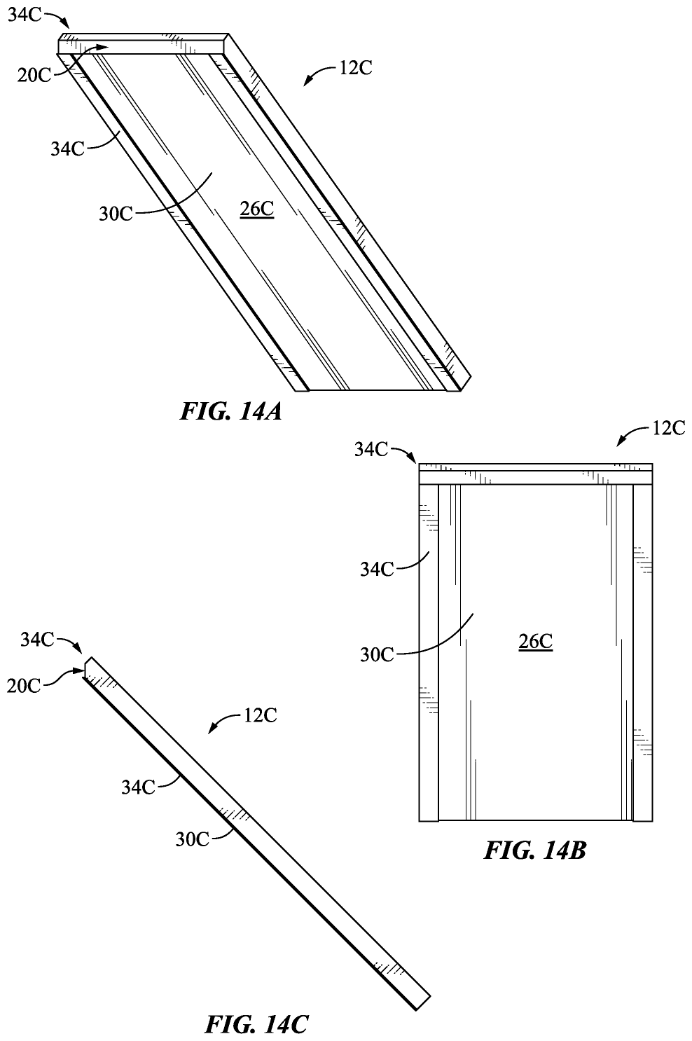

FIG. 14A is a schematic back perspective view of another example of a cover pad shown at an approximate angle suitable for insertion into the container and above the shelf of FIG. 1. FIG. 14B is a schematic side view of the cover pad at the angle shown in FIG. 14A. FIG. 14C is a schematic back view of the cover pad at the angle shown in FIG. 14A. This embodiment of a cover pad 12C functions similarly to the above described embodiments of the cover pads, particularly the embodiment in FIGS. 13A-13C, in that this embodiment uses a spreader surface 20C to spread fluids across a flow surface 26C of the cover pad underside 30C. However, this embodiment forms the spreader surface 20C substantially across the top 34C width (y edge) to spread the fluid flow across more of the flow surface 26C. This embodiment further includes spacing strips 32C along the length (x edge) for providing a similar space 38 when the cover pad 12C is placed over the planar support surface of the shelf 6 as described above and shown in FIGS. 10 and 11.

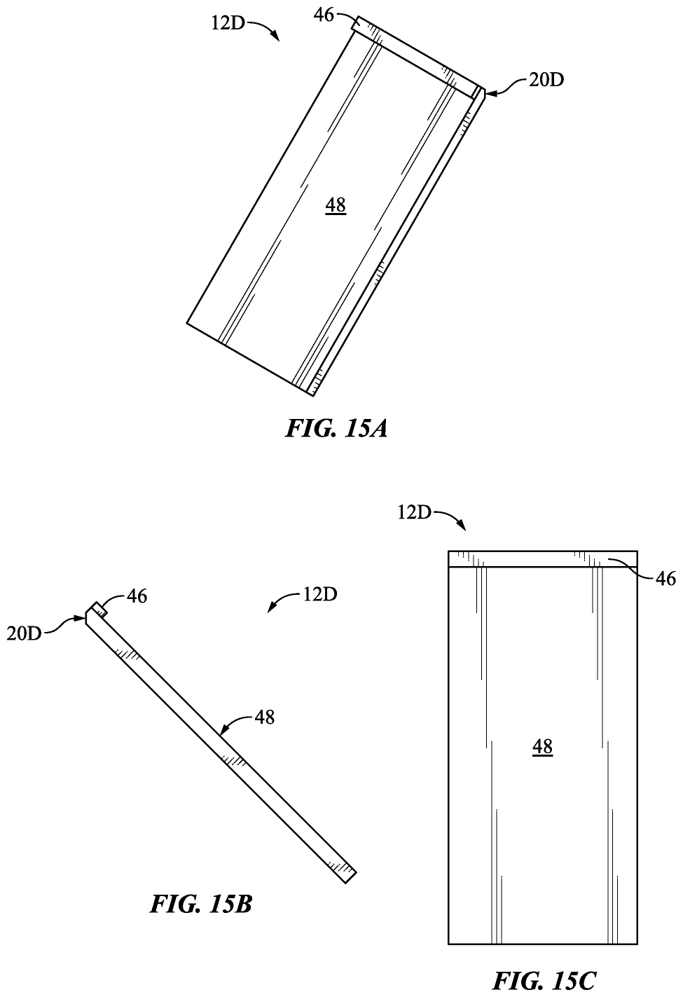

FIG. 15A is a schematic front perspective view of another example of a cover pad shown at an approximate angle suitable for insertion into the container and above the shelf of FIG. 1. FIG. 15B is a schematic side view of the cover pad at the angle shown in FIG. 15A. FIG. 15C is a schematic front view of the cover pad at the angle shown in FIG. 15A. This embodiment (as well other embodiments described herein) can include a layer 46 of hydrophobic material on an outward surface 48 of the cover pad that is distal from the shelf 6, described above, when placed on the shelf. The layer 46 can assist with fluid retention of fluid deposited on a planar support 14, shown in FIG. 11 that flows downward toward the cover pad 12 by forming a barrier to the restrain the fluid from flowing over the cover pad. The layer 46 can be used on any of the embodiments disclosed herein and other embodiments.

Other and further embodiments utilizing one or more aspects of the inventions described above can be devised without departing from the disclosed invention as defined in the claims. For example, other embodiments can include different shapes and length of the spreader surface, side flow bars, side flow guides, and spacing strips, locations of the side flow guides, and spacing strips and variations than those specifically disclosed herein within the scope of the claims.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intend to protect fully all such modifications and improvements that come within the scope of the following claims.

What is claimed is:

1. A histological containment system comprising a cover pad to be placed on a planar support with a histological sample on a topside of the planar support, the planar support being placed on a container shelf, the cover pad comprising:
a flow surface (26) formed on an underside of the cover pad (12) when the cover pad is installed over the planar support (14) and facing the topside of the planar support;
a spreader surface (20) on a top portion (34) of the cover pad and configured to direct fluids toward sides of the cover pad; and
a side flow bar (18) disposed toward at least one side of the cover pad, the side flow bar configured to restrain fluids along the spreader surface from flowing off the planar support (14) past the side flow bar.

2. The histological containment system of claim 1, further comprising a side flow guide (22) toward the at least one side of the cover pad that intersects the spreader surface toward the side and the side flow bar toward the side and configured to direct fluids flowing toward the side along the spreader surface to flow under the cover pad and flow over the planar support disposed under the cover pad.

3. The histological containment system of claim 1, further comprising a spacing strip (32) on the at least one side of the cover pad and configured to create a space (38) between the cover pad and the planar support under the cover pad.

4. The histological containment system of claim 1, wherein the spreader surface is curved toward the top portion of the cover pad and sloping away from the top portion toward the sides of the cover pad.

5. The histological containment system of claim 1, further comprising a layer (48) of hydrophobic material formed on an outward surface (48) of the cover pad.

6. A histological containment system comprising a cover pad to be placed on a planar support with a histological sample on a topside of the planar support, the planar support being placed on a container shelf, the cover pad comprising:
a flow surface (26) on an underside of the cover pad facing the topside of the planar support; and
a spreader surface (20) on a top portion (34) of the cover pad and configured to direct fluids toward sides of the cover pad to distribute flow across the surface of the planar support under the cover pad.

7. The histological containment system of claim 6, further comprising a spacing strip (32) on the at least one side of the cover pad and configured to create a space (38) between the cover pad and the planar support under the cover pad.

8. The histological containment system of claim 6, wherein the spreader surface (20) is curved toward the top portion of the cover pad and sloping away from the top portion toward the sides of the cover pad.

9. The histological containment system of claim 6, wherein the cover pad (12) comprises a shape of a parallelepiped with dimensions x,y,z, where x represents the longest edge, y represents the medium-length edge, and z represents the shortest edge, further comprising two parallel spacing strips (32) formed on an underside (30) of the cover pad along the x edges, and wherein a y edge is chamfered at least partially across the y edge to form a spreader surface (20) to direct flow of a fluid under the cover pad.

10. The histological containment system of claim 9, wherein the spreader surface (20) is fully across the y edge.

11. The histological containment system of claim 9, further comprising a layer (48) of hydrophobic material formed on an outward surface (44) of the cover pad.

12. The histological containment system of claim 6, further comprising a layer (48) of hydrophobic material formed on an outward surface (48) of the cover pad.

13. A histological containment system comprising a cover pad (12) to be placed on a planar support (14) with a histological sample on a topside (44) of the planar support, the planar support being placed on a shelf (6) in a container (4), the cover pad comprising a shape of a parallelepiped with dimensions x,y,z, where x represents the longest edge, y represents the medium-length edge, and z represents the shortest edge, further comprising two parallel spacing strips (32) formed on an underside (30) of the cover pad along the x edges, and wherein a y edge is chamfered at least partially across the y edge to form a spreader surface (20) to direct flow of a fluid under the cover pad.

14. The histological containment system of claim 13, wherein the spreader surface (20) is fully across the y edge.

15. The histological containment system of claim 13, further comprising a layer (48) of hydrophobic material formed on an outward surface (44) of the cover pad.

16. A method of processing a histological sample, comprising:
placing a cover pad (12) over a planar support (14) having a sample (16) mounted on the planar support;
depositing one or more fluids on the planar support that flow over the planar support and under the cover pad across the sample to create a histological staining pattern on the sample; and
flowing a mounting medium over the planar support and under the cover pad.

17. The method of claim 16, comprising iteratively repeating at least depositing the one or more fluids on the planar support.

18. The method of claim 16, further comprising imaging the sample directly through the cover pad.

19. The method of claim 16, further comprising curing the mounting medium to produce a permanent mounting of the sample.

20. The method of claim 19, wherein the curing comprising applying an ultraviolet light to the mounting medium.
